(19) United States
(12) Patent Application Publication
(10) Pub. No.: US 2014/0081651 A1
(43) Pub. Date: Mar. 20, 2014

(54) HEALTHCARE PAYMENT AND PROCESSING SYSTEM AND METHOD

(71) Applicants: Gaines S. Dittrich, Stella, MO (US); Dee E. Renshaw, Okmulgee, OK (US); Don Lowenstein, Cameron, MO (US); Michael A. Campbell, St. Louis, MO (US)

(72) Inventors: Gaines S. Dittrich, Stella, MO (US); Dee E. Renshaw, Okmulgee, OK (US); Don Lowenstein, Cameron, MO (US); Michael A. Campbell, St. Louis, MO (US)

(21) Appl. No.: 14/026,663

(22) Filed: Sep. 13, 2013

Related U.S. Application Data
(60) Provisional application No. 61/701,297, filed on Sep. 14, 2012.

(51) Int. Cl. G06Q 50/22; G06Q 20/10

(52) U.S. Cl. CPC G06Q 50/22; G06Q 20/102
USPC 705/2

(57) ABSTRACT

A system and process for providing a flexible and automated ACH-payment processing service to hospital organizations and health care providers with respect to the payment of patient self-pay accounts under payment plans in compliance with the requirements of 26 U.S.C. §501(r), for automating the system service charge calculations paid by the hospital organizations and health care providers, and for providing automated reports to comply with requirements of 26 U.S.C. §501(r) and proposed regulations at 26 C.F.R. §1.501(r).

### CROSS REFERENCE TO RELATED APPLICATIONS

This application claims the priority of U.S. provisional application No. 61/701,297, filed Sep. 14, 1012, the entire disclosure of which is hereby incorporated by reference.

### FEDERALLY SPONSORED RESEARCH OR DEVELOPMENT

Not Applicable.

### COMPACT DISK APPENDIX

Not Applicable.

### BACKGROUND

All tax exempt hospital organizations are required by law to meet four requirements to maintain their tax exempt status. These requirements include: (A) meeting prescribed community health needs assessment requirements, (B) meeting certain financial assistance policy requirements, (C) meeting requirements and limitations on patient charges, and (D) complying with limitations on billing and collection requirements. See 26 U.S.C. §501(r)(1). It is therefore necessary for hospitals to utilize systems and policies that establish compliance with these requirements to maintain their tax-exempt status.

Of particular importance is the Internal Revenue code requirement that hospital organizations have a “written financial assistance policy” and the prohibition of hospital organizations from engaging in “extraordinary collection actions before the organization has made reasonable efforts to determine whether the individual is eligible for assistance.” See 26 U.S.C. §501(r).

The “written financial assistance policy” for each hospital organization must include: (i) eligibility criteria for financial assistance, including whether the assistance includes free or discounted care; (ii) the basis for calculating amounts charged to patients; (iii) the method for applying for financial assistance; (iv) the actions the hospital organization may take in the event of non-payment; and (v) measures to widely publicize the policy within the community served by the organization. See 26 U.S.C. §501(r)(4)(A). Of particular importance is the description of “the actions the organization may take in the event of non-payment, including collections action and reporting to credit agencies” and “the actions the organization may take in the event of non-payment.”

A hospital organization is not allowed to perform any “extraordinary collection actions,” which include: (1) Placing a lien on an individual's property; (2) Foreclosing on an individual's real property; (3) Attaching or seizing an individual's bank account or any other personal property; (4) Commencing a civil action against an individual; (5) Causing an individual's arrest; (6) Causing an individual to be subject to a writ of body attachment; and (7) Garnishing an individual's wages.

An automated process is needed to enable hospitals to fulfill the above described requirements by establishing that the hospital has employed a payment system to enable its patients to pay their obligations without resort to these enumerated “extraordinary collection actions.”

### SUMMARY

A system is provided that enables healthcare organizations to establish an account for each self-pay patient whereby the patient makes monthly payments on obligations owed to the hospital via automated clearing house (ACH) auto-debit agreements that are administered by a third party processor. The system includes at least one processor that executes an application to process ACH payment requests. The third party processor inputs data concerning the patient obligation and repayment terms to generate the ACH payment processing request that is provided to the system. The application executes processing instructions to automatically process periodic (e.g., weekly, bi-monthly, monthly) ACH payment requests and transactions and to calculate a service charge. The system also includes a database that may be accessed at any time by the hospital or patient, and then calculates all patient payments (net of service charges) for remittance to the hospital.

According to another aspect, a system is provided to enable healthcare organizations to establish that the hospital has a “written financial assistance policy.” The written financial assistance policy includes a description of “the actions the organization may take in the event of non-payment, including collection actions and reporting to credit agencies” that includes an automated payment system that enables patients to pay their obligations with an automatic ACH process. The written financial assistance policy also establishes that the hospital organization has employed an automated payment system without resort to “extraordinary collection actions” that are typical of conventional patient obligation enforcement methods.

### BRIEF DESCRIPTION OF THE DRAWINGS

FIG. 1A is a block diagram of a computing system that includes an automated payment processing system.

FIG. 1B depicts an exemplary embodiment of a client computer according to one aspect of the automated payment processing system.

FIG. 1C depicts an exemplary embodiment of a client computer according to one aspect of the automated payment processing system.

FIG. 2 is an example of the ACH authorization form for use in authorizing and establishing the auto-debit process utilized by the automated payment processing system.

FIGS. 3-7 are screen shots of exemplary administrative data input forms.

FIG. 8 is an example method of performing automatic ACH transactions.

FIGS. 9-12 are exemplary reports generated by the system.

### DETAILED DESCRIPTION

Aspects of a payment processing system described herein provide an improved system and method for institutions or organizations to receive payments for services rendered. The system allows for an institution or organization, such as a healthcare organization, to establish an account for each self-pay patient that allows for the patient to make regular payments on obligations owed to the healthcare organization using automated clearing house (ACH) auto-debit agreements.

Specifically, the system includes an automated process that enables hospital organizations to establish monthly payment plans with their patients that permit patients to pay their obligations with a convenient and automatic the Automated Clearing House (ACH) process that fulfills a hospital organization's obligation to have a “written financial assistance policy.” Additionally, this automated process generates monthly reports for these hospitals that enable the hospitals to fulfill the requirements for hospitals to not take “extraordinary collection actions before the organization has made reasonable efforts to determine whether the individual is eligible for assistance” by establishing at least one of the actions that the hospital may take in the event of non-payment, providing a convenient alternative to traditional collection actions. The system also automatically generates reports for hospitals that enable the hospitals to: (1) demonstrate their compliance with the above-mentioned requirements of 26 U.S.C. §501(r); and (2) complete the required descriptions of systems and policies on Part VI of Schedule H of IRS Form 990.

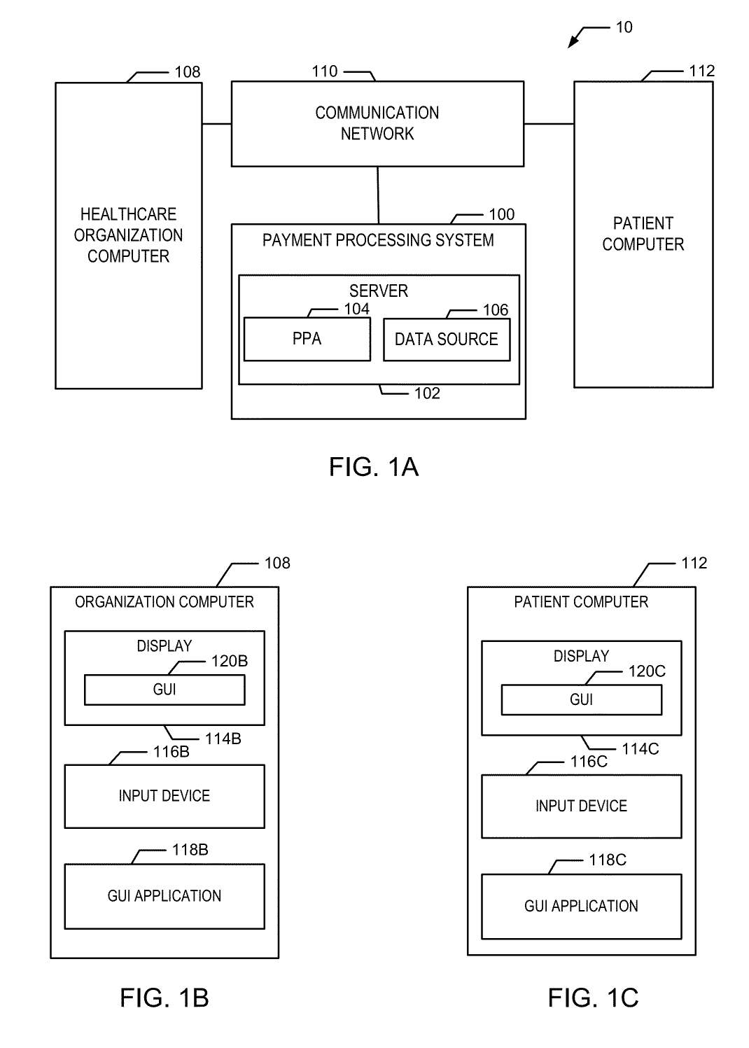

Referring now to FIG. 1A, an exemplary computing network 10 that includes a payment processing system (PPS) 100 in accordance with aspects of the invention is depicted. The PPS 100 includes a third party server computer (server) 102 that includes a payment processing application (PPA) 104 and a data source 106. The PPS 100 is linked to one or more healthcare organization computing devices (e.g., organization computer) 108 via a communication network 110 and one or more patient computing devices (e.g., patient computer 112). Although the data source 106 is shown as being located on, at, or within the server 102, it is contemplated that the data source 106 can be located remotely from the server 102 in other aspects of the PPS 100, such as on, at, or within a database of another computing device or system having at least one processor and volatile and/or non-volatile memory.

The server 102 is a computer or other computing device that includes one or more processors and memory and executes the PPA 104 to manage the storage of patient financial data and/or institution identification data in the data source 106. The PPA 104 is also executed to manage the creation and transmission of an electronic (e.g., ACH) payment request on the behalf of a particular patient and/or a particular customer of a healthcare organization.

Patient financial data includes, for example, name of the patient, an account number assigned to the patient by the PPS 100 and/or patient personal financial account data, such as bank name/ID, bank routing and transit number (RTN), and bank account number. The patient financial data may also include an email address, a phone number, a mailing address, and/or other contact information for the patient. The institution identification data may include names of one or more institutions (e.g., healthcare organizations) that accept electronic payments via the PPS 100 and/or authentication information (e.g., user identification code and/or a password) for patients that are approved for ACH payments.

According to one aspect, the generated ACH payment request includes patient financial data to enable the healthcare organization computing device 108 that receives the payment request to retrieve payment from a banking institution to cover all or a portion of an outstanding balance for a corresponding patient. For example, the ACH payment request may include bank name/ID, bank routing and transit number (RTN), and bank account number for a particular patient and may payment amount to transfer to the healthcare organization on behalf of that particular patient.

The server 102 is configured to receive data from and/or transmit data to the one or more organization computers 108 and/or patient computers 112 through the communication network 110. Although the PPS 100 is depicted as including a single server 102, it is contemplated that the PPS 100 may include multiple servers in, for example, a cloud computing configuration.

According to another aspect, an input device (e.g., keyboard and monitor) enables an administrative user of the server 102 to interact with various data entry forms to enter patient financial data for the purpose of authorizing the PPS 100 to periodically generate ACH payment request. For example, an administrative user of the server 102 may enter financial data included on a paper form received from a particular patient.

According to another aspect, a scanning device is connected to server via a wired or wireless communication link. The scanning device enables an administrative user to create an electronic copy of an ACH authorization form and/or document (e.g., check) for storage in a database (e.g. data sources 106).

The communication network 110 can be the Internet, an intranet, or another wired or wireless communication network. For example, communication network 110 may include a Mobile Communications (GSM) network, a code division multiple access (CDMA) network, 3rd Generation Partnership Project (3GPP), an Internet Protocol (IP) network, a Wireless Application Protocol (WAP) network, a WiFi network, or any IEEE 802.11 standard network, as well as various combinations thereof. Other conventional and/or later developed wired and wireless networks may also be used.

FIG. 1B depicts an exemplary embodiment of the organization computer 108 according to one aspect of the PPS 100. The organization computer 108 is a computing or processing device that includes one or more processors and memory and is configured to receive data and/or communications from, and/or transmit data and/or communications to the server 102 via the communication network 110. For example, the organization computer 108 can be a standard personal computer, laptop, local server computer, tablet computer, smart phone, or another processing device. The organization computer 108 is configured to securely receive data and/or communications from, and/or securely transmit data and/or communications to a banking institution server 102 of a patient via the communication network 110. The patient computer 112 includes a display 114B, such as a computer monitor, for displaying data and/or graphical user interfaces (GUI) 120B. The organization computer 108 may also include an input device 116B, such as a keyboard or a pointing device (e.g., a mouse, trackball, pen, or touch screen) to enter data into or interact with graphical user interfaces 120B.

Each organization computer 108 may also include a graphical user interface (GUI) application 118B, such as a browser application, to generate a graphical user interface 118B on the display 114B. The graphical user interface 118B enables an administrative user to generate an access request (not shown) to access a web service provided by the PPS 100. The access request is generated, for example, by the user entering a uniform resource locator (URL) that corresponds to the location of the PPA 104 on the server 102 via the graphical user interface 118B. Thereafter, the user can utilize the input device 116B to interact with an authentication data entry form to submit an authentication request to the PPS 100 and gain access to the third party payment processing system (e.g., PPS 100). Authentication may take place, for example, by requiring a user to fill out complete data entry form (e.g., login) that requires the user to provide a username and a password.

FIG. 1C depicts an exemplary embodiment of the patient computer 112 according to one aspect of the PPS 100. The patient computer 112 is a computing or processing device that includes one or more processors and memory and is configured to receive data and/or communications from, and/or transmit data and/or communications to the server 102 via the communication network 110. For example, the patient computer 112 can be a standard personal computer, laptop, local server computer, tablet computer, smart phone, or another processing device. The patient computer 112 includes a display 114C, such as a computer monitor, for displaying data and/or graphical user interfaces (GUI) 120C. The organization computer 108 may also include an input device 116C, such as a keyboard or a pointing device (e.g., a mouse, trackball, pen, or touch screen) to enter data into or interact with graphical user interfaces 120C.

Each patient computer 112 may also include a graphical user interface (or GUI) application 118C, such as a browser application, to display on or more administrative forms on the display 114C. A graphical user interface 120C enables the administrator to interact with the various data entry forms to submit patient financial data for the purpose of authorizing the PPS 100 to periodically generate ACH payment request. For example, a particular administrative user of the patient computer 112 may input financial data into an electronic authorization form on the display 114C and/or transmit an electronic copy of a document (e.g., check) for storage in a database (e.g. data source 106).

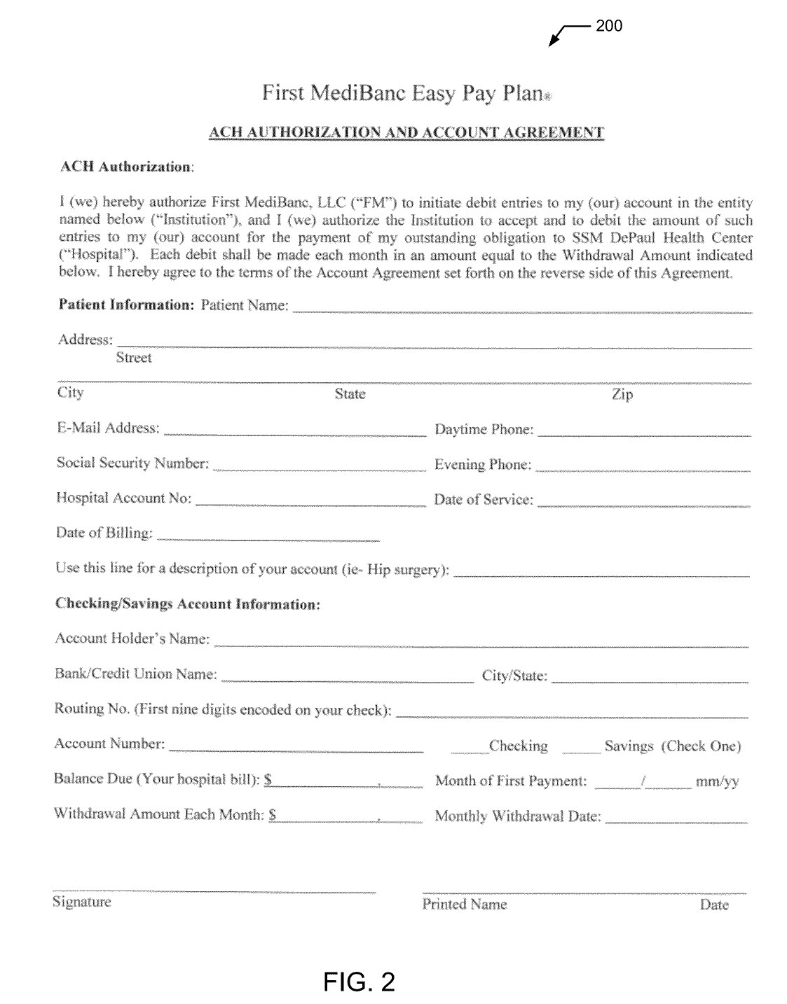

FIG. 2 depicts an exemplary electronic payment authorization form 200. The electronic payment authorization form 200 may include an authorization to allow for ACH transactions, a patient name and personal information, including the patient's home address, email address, phone number(s), social security number, hospital account number, the date services were provided, the date of billing, and a description of the services. The electronic payment authorization form may also include checking or savings account information for performing ACH auto-debit transactions. The checking or savings account information may include the account holder's name, the bank's name and city/state, a routing number for the bank, an account number, a designation of account type (e.g., checking or savings), a total balance due, a date of the first auto-debit, a monthly payment amount, and a monthly withdrawal date.

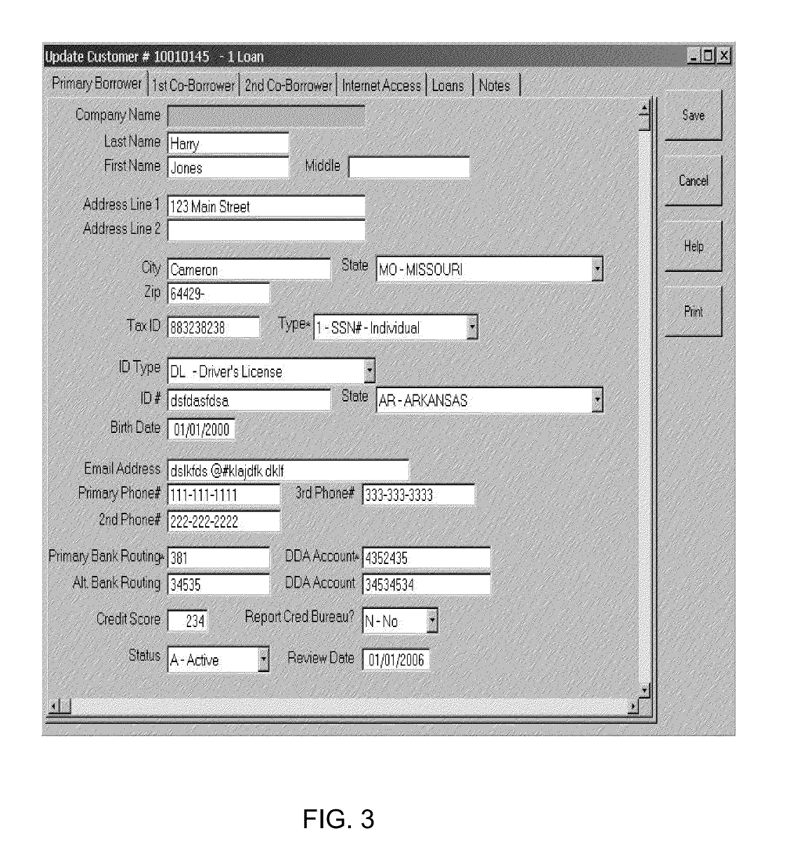

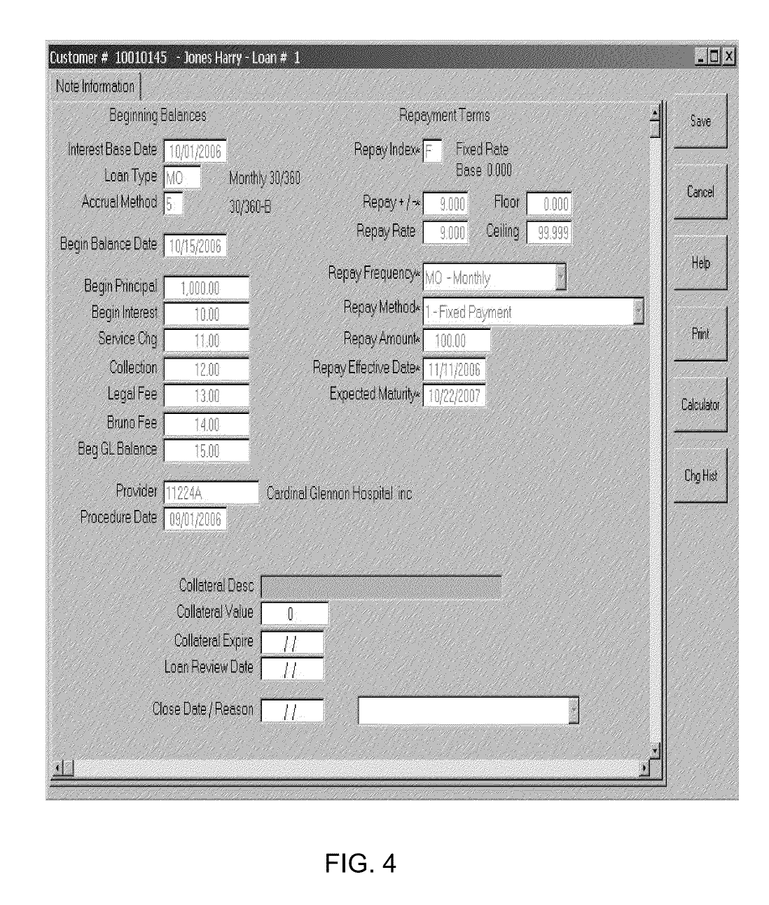

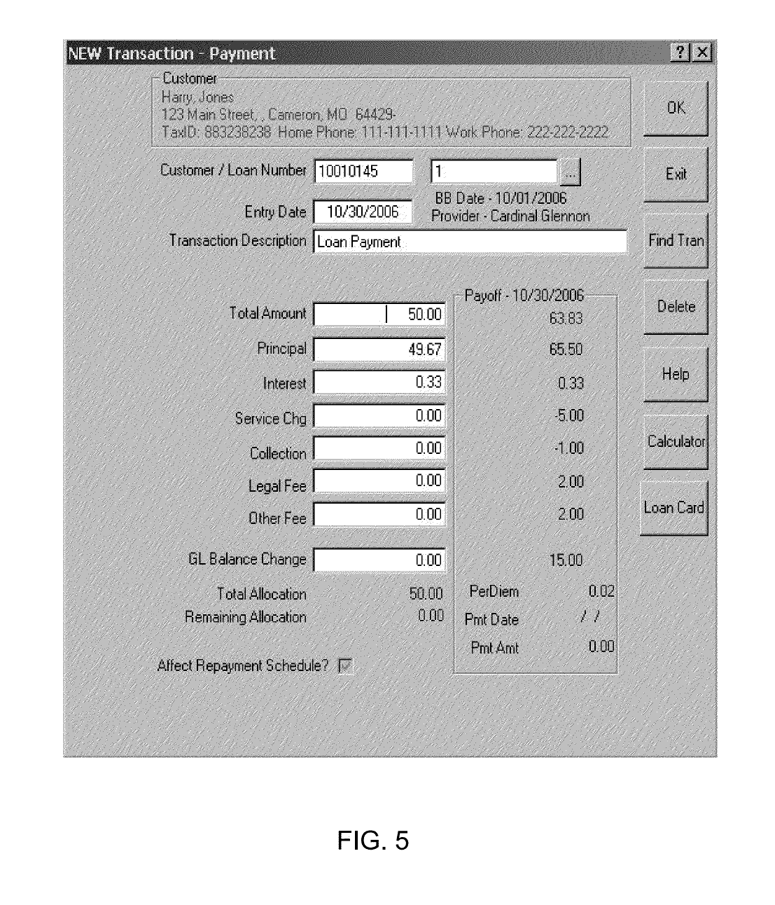

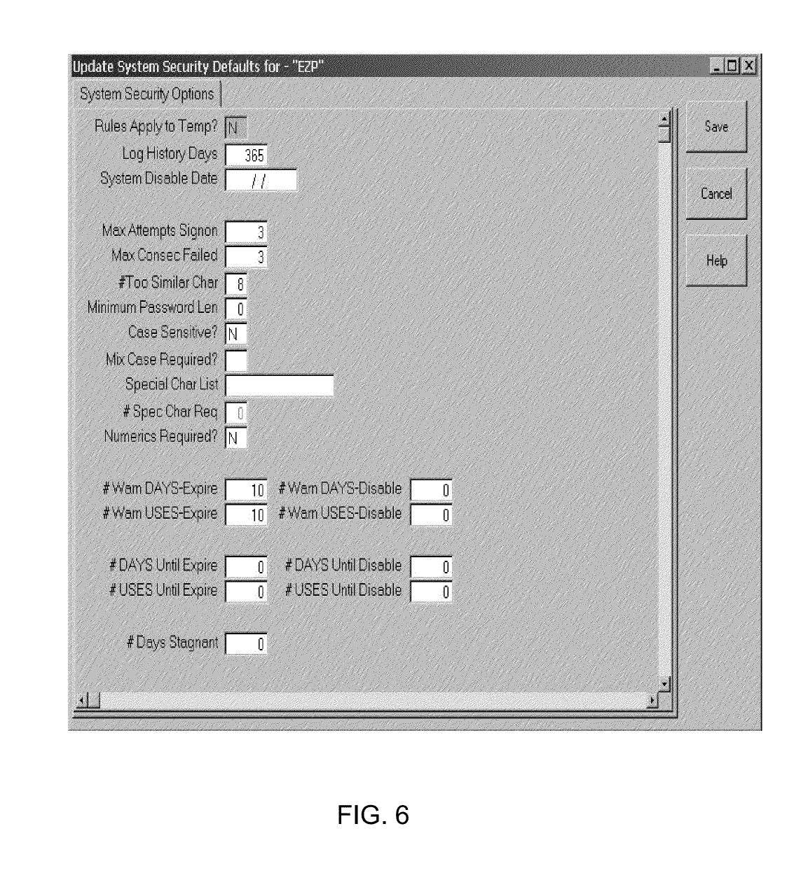

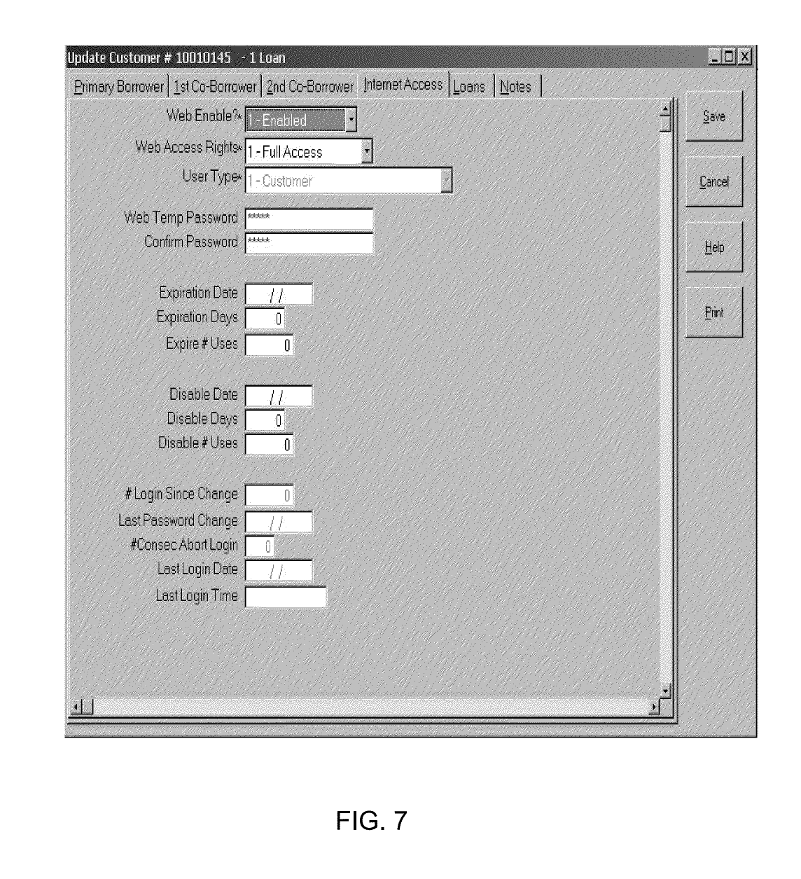

The administrative user can interact with various other data entry forms to enter or modify financial data for the patient, set up accounts for a patient, enter payment information for a patient, and manage system security settings. FIGS. 3-7 depicts examples of such administrative data entry forms and include an administrative data entry form that allows the administrative user to update a patient or borrower's personal information, as well the information of any co-borrowers, information about the loan the patient is repaying, the security settings for accessing the system, and account notes.

The sever 102 executes the PPA 114 to initiate periodic payments to a healthcare organization according to patient financial data and bank identification data stored in the database. The following is an illustrative example of process steps associated with executing the PPA 114 according to one aspect of the PPS 100 ACH auto-debit agreements are maintained by a third party processor (e.g., PPS 100) that inputs: (1) the total patient obligation into its software (e.g., PPA 112) and database (described herein), (2) the monthly payment amount agreed to between the hospital and patient, (3) the patient bank's routing number at which the patient maintains a demand deposit account, (4) the demand deposit account number of the patient account, (5) an obligation identifier (consisting of a patient-generated or hospital-generated description of the obligation, and (6) the agreed service charge (either as a dollar amount or a percentage of payment amounts) to be retained by the third party processor upon each auto-debit. The system, consisting of a package of integrated software and database components, then automatically processes each monthly ACH payment request and transaction, calculates the required service charge, maintains a database that may be accessed at any time by the hospital or patient, and then calculates all patient payments and service charges for remittance to the hospital. The system and programs also provide automated reports to enable hospital organizations to comply with requirements of 26 U.S.C. §501(r) and proposed regulations at 26 C.F.R. §1.501(r).

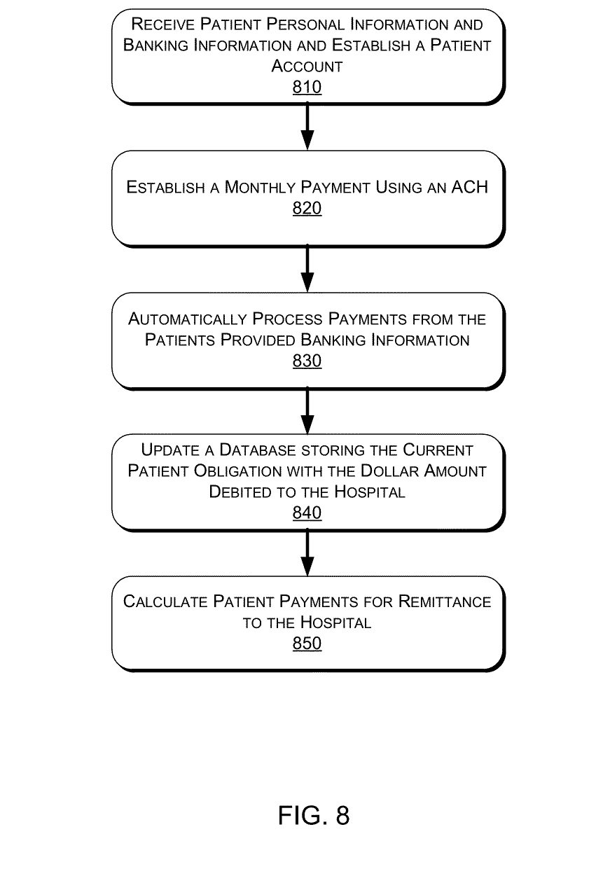

FIG. 8 depicts a method of processing a payment using the PPS 100. A patient may receive and fill out an electronic payment authorization form, such as the exemplary electronic payment authorization form 200. The electronic authorization form includes any information necessary for setting up ACH auto-debit transactions. An administrator for the PPS 100, a hospital organization employee, or the patient may enter this information into a computing device that is capable of sending the information from the electronic payment authorization form to the data source 106. For example, a hospital administrator may use the various forms depicted by FIGS. 3-7 to enter the electronic payment authorization form information into the data source 106. As discussed above, the data source 106 may include a database of patient accounts along with any account history for the accounts. Thus, the PPS system 100 receives a patient's personal and banking information via the electronic payment authorization form and uses the information to setup a patient account for conducting ACH auto-debit transactions (operation 810). A payment schedule for processing ACH payments to the hospital organization may then be established (operation 820). The payment schedule may be designated by the electronic payment authorization form or may be set by the PPS 100 to a default monthly payment according to the term of the payment plan, the total amount owed to the hospital organization, and any fees or interest that will be charged to the patient. The PPS 100 automatically processes the ACH debit transactions according to the payment schedule by crediting the account from the provided banking information and credits the account of the hospital organization (operation 830). In some cases, the PPS system 100 may charge a fee for processing the ACH transaction. In these cases, the fee is automatically added to the debit of the patient's bank account. After each transaction, a database stored at data source 106 may be updated to reflect the transaction (operation 840). The PPS system 100 also calculates the required payment for remittance to the hospital and updates the database to include the current remittance (operation 850).

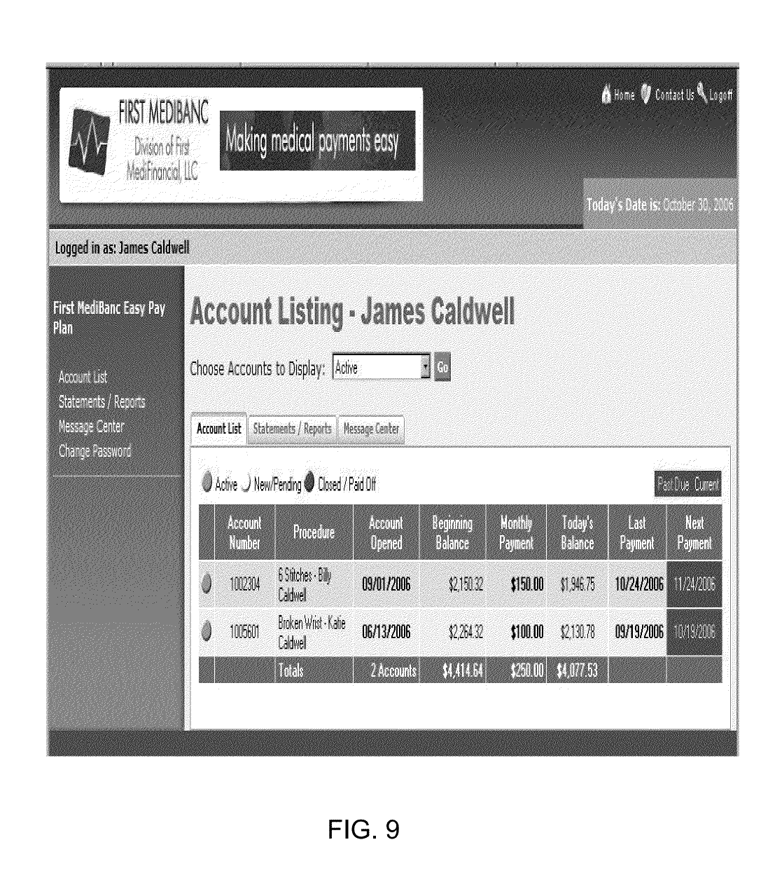

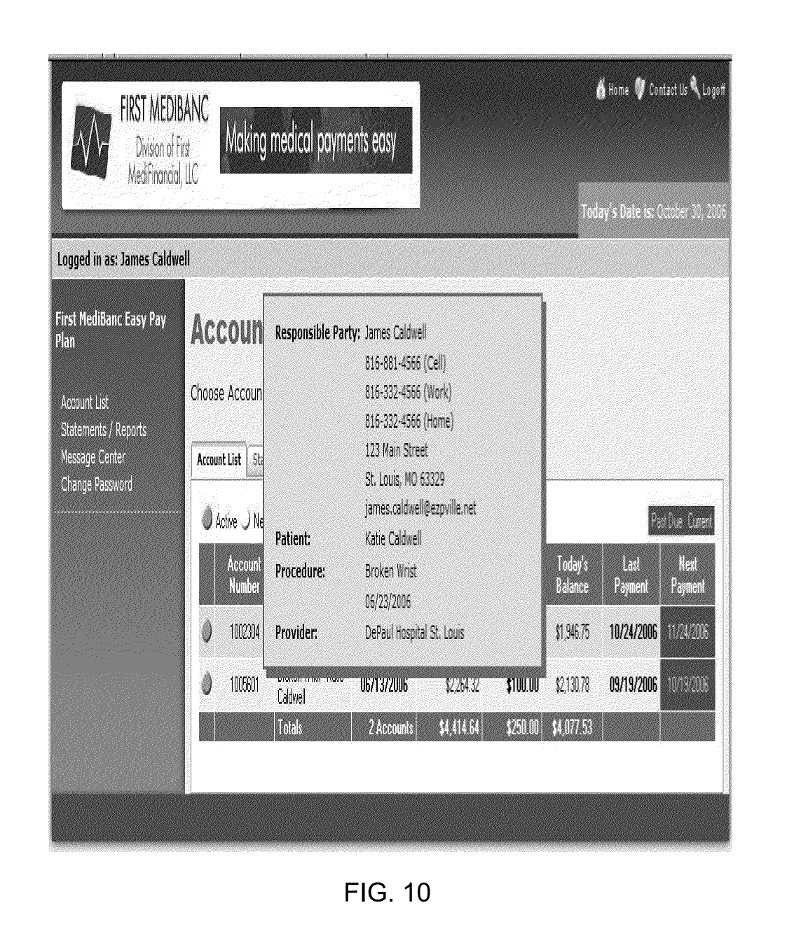

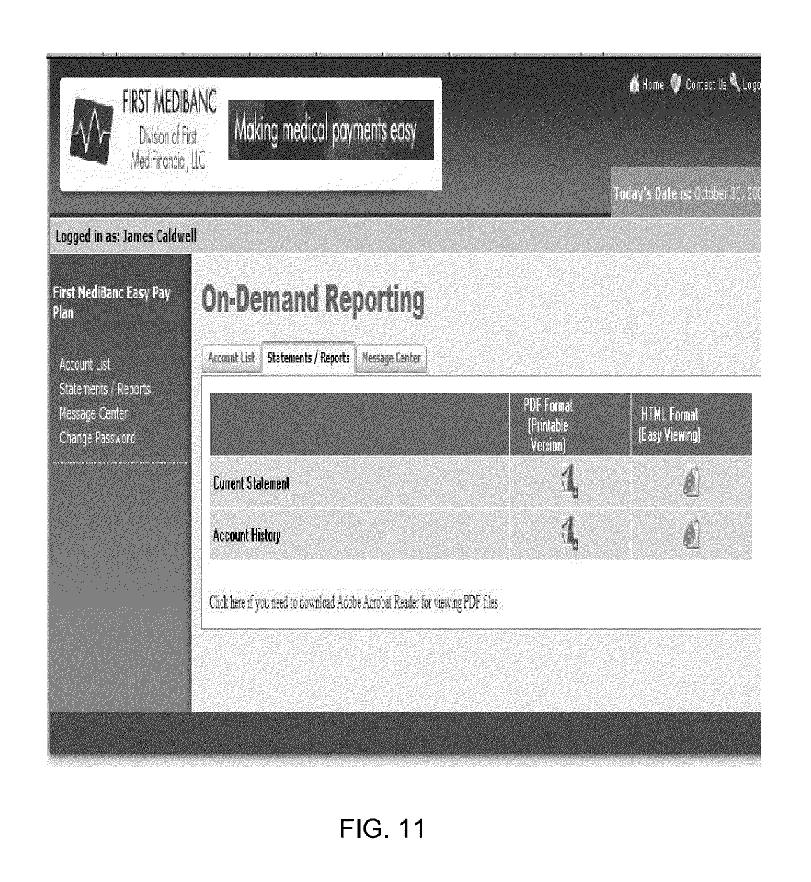

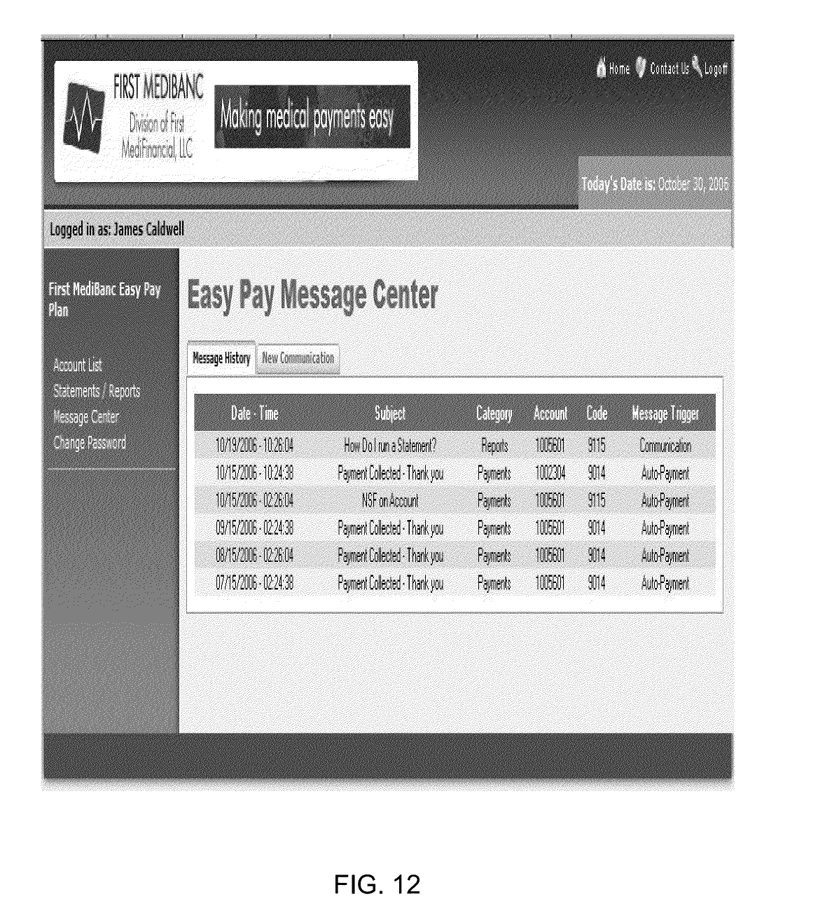

The PPS system 100 may also be configured to automatically generate reports detailing the patient accounts with currently outstanding balances. Examples of automated reports may include a physical or electronic report for use by the hospitals in reporting a summary of patient payment obligations collected during a prescribed time period and a report for use by the hospitals in viewing information on any individual patient payment obligations collected during a prescribed time period, and the balance of the patient obligation remaining FIGS. 9-12 depicts examples of various reports that may be generated.

Those skilled in the art will appreciate that variations from the specific embodiments disclosed above are contemplated by the invention. The invention should not be restricted to the above embodiments, but should be measured by the following claims.

What is claimed is:

1. A payment processing system, comprising:
at least one processor;
an application executed by the at least one processor to:
administer an Automated Clearing House (ACH) auto-debit agreement that includes a patient obligation to a hospital organization and repayment terms, wherein the processing system:
automatically process a payment request that credits a dollar amount specified by the repayment terms from a patient account plus a calculated service charge and debits the dollar amount to a hospital organization account minus a calculated service charge;
updates a database storing the patient obligation with the dollar amount debited to the hospital organization;
provides access to the database to a patient and a hospital; and
calculates a patient payment for remittance to the hospital including a net service charge and update the database to include the patient payment for remittance.

2. The system of claim 1, wherein the hospital organization establishes a patient account for payment of patient obligations.

3. The system of claim 2, wherein the patient account comprises:
a total payment obligation;
a monthly payment amount agreed to by the hospital organization and patient;
a demand deposit account number for a patient account at a patient bank;
a patient bank routing number for the patient bank;
an obligation identifier; and
a service charge to be retained by the third party processor upon each auto-debit.

4. The system of claim 1, wherein the patient executes the ACH auto-debit agreement to authorize automatic debits from the patient account.

5. The system of claim 1, wherein a third party provider inputs data provided by the hospital organization and patient to initiate the ACH auto-debit agreement.

6. The system of claim 1, wherein the system automatically initiates an auto-debit request to a financial institution for the patient account payment to the hospital organization account, wherein the hospital organization account is maintained by a third party provider.

7. The system of claim 1, wherein the system automatically calculates the calculated service charge between the hospital organization and the third party provider.

8. The system of claim 1, wherein the system automatically generates a report to accompany the remittance to the hospital organizations.

9. The system of claim 7, where in the report comprises at least one of a paper transmission or electronic funds transmission.

10. The system of claim 7, wherein the report accompanies the remittance to the hospital organization.

11. The system of claim 7, wherein the report is generated on a monthly and annual basis.

12. The system of claim 1, wherein the system further comprises a secure network connection configured to allow the patient and the hospital organization to access the database storing the patient obligation.

13. A payment processing system, comprising:
at least one processor;
an application executed by the at least one processor to:
administer an Automated Clearing House (ACH) auto-debit agreement that includes a patient obligation to a hospital organization and repayment terms, wherein the processing system:
automatically process a payment request that credits a dollar amount specified by the repayment terms from a patient account plus a calculated service charge and debits the dollar amount to a hospital organization account minus a calculated service charge;
updates a database storing the patient obligation with the dollar amount debited to the hospital organization;
provides access to the database to a patient and a hospital;
calculates a patient payment for remittance to the hospital including a net service charge and update the database to include the patient payment for remittance; and
automatically generate a report including a summary of the patient obligation, the amount credited to the hospital organization account over a time period, and the balance of the patient obligation remaining

14. The system of claim 13, wherein the hospital organization establishes a patient account for payment of patient obligations.

15. The system of claim 14, wherein the patient account comprises:
a total payment obligation;
a monthly payment amount agreed to by the hospital organization and patient;
a demand deposit account number for a patient account at a patient bank;
a patient bank routing number for the patient bank;
an obligation identifier; and
a service charge to be retained by the third party processor upon each auto-debit.

16. A method for automatically processing payments for a hospital organization using at least one processor, the method comprising:
automatically processing a payment request that credits a dollar amount specified by repayment terms from a patient account plus a calculated service charge and debits the dollar amount to a hospital organization account minus a calculated service charge;
updating a database storing the patient obligation with the dollar amount debited to the hospital organization;
providing access to the database to a patient and a hospital;
calculating a patient payment for remittance to the hospital including a net service charge and update the database to include the patient payment for remittance; and
automatically generating a report including a summary of the patient obligation, the amount credited to the hospital organization account over a time period, and the balance of the patient obligation remaining

17. The method of claim 16, further comprising receiving from the hospital organization establishes a patient account for payment of patient obligations.

18. The system of claim 17, wherein the patient account comprises:
a total payment obligation;
a monthly payment amount agreed to by the hospital organization and patient;
a demand deposit account number for a patient account at a patient bank;
a patient bank routing number for the patient bank;
an obligation identifier; and
a service charge to be retained by the third party processor upon each auto-debit.
